(19) United States
(12) Patent Application Publication
(10) Pub. No.: US 2022/0050566 A1
(43) Pub. Date: Feb. 17, 2022

(54) SYSTEM AND METHOD FOR PROVIDING A DYNAMIC CALENDAR

(71) Applicant: Catalin Lefter, Alessandria (IT)

(72) Inventor: Catalin Lefter, Alessandria (IT)

(21) Appl. No.: 17/513,698

(22) Filed: Oct. 28, 2021

Related U.S. Application Data
(63) Continuation of application No. 16/600,989, filed on Oct. 14, 2019, now abandoned.
(60) Provisional application No. 62/744,968, filed on Oct. 12, 2018.

(51) Int. Cl. G06F 3/0486; G06F 3/0488; G06Q 10/10

(52) U.S. Cl. CPC G06F 3/0486; G06F 3/04883; G06F 2203/04806; G06Q 10/1093; G06F 3/04886

(57) ABSTRACT

A dynamic calendar and scheduling system having a display in communication with a computing device is provided. The display shows a timeline having a plurality of prescheduled calendar events. A processor is in operable communication with the computing device and identifies a gesture via a sensing module. A zoom module determines whether the gesture corresponds to a zooming-in or a zooming-out. The magnitude of the gesture is measured by a time scale calculation module, and an adjusted timeline is displayed.

### CROSS-REFERENCE TO RELATED APPLICATIONS

The present application claims priority to U.S. Provisional Application No. 62/744,968 filed on Oct. 12, 2018, entitled “SYSTEM AND METHOD FOR PROVIDING A DYNAMIC CALENDAR” the entire disclosure of which is incorporated by reference herein.

### TECHNICAL FIELD

The embodiments relate to a system for providing a dynamic calendar, further providing a zoom in and zoom out function to the user on a mobile computing device.

### BACKGROUND

Computing devices, whether mobile or non-mobile, exist which display calendars on a graphics display. Some of these include application programs, sometimes referred to as schedulers, which display fixed time increments or scheduling periods in days, weeks, and months. Scheduled events can include events, birthdays, appointments, travel dates, exercise periods, wake-up times, holidays, and other notable occurrences.

In the current fixed display systems, time scales are displayed by clicking on the period of time to be viewed (such as a specific day, week, month, etc.). These systems do not allow for variable viewing of the calendar, forcing the user to click-through various time periods to view scheduled events. Personal electronic devices (PED's) allow phone conversations, application integrations, scheduling, and other interactions to occur simultaneously. With each newly scheduled event, the information on the calendar becomes increasingly dense, making it difficult for users to comprehend the variety of entries over a period of time. Scheduling and event planning is compounded as the screen size of PED's becomes smaller, making it more difficult for persons to quickly find, navigate, and comprehend the information contained on the calendar.

### SUMMARY OF THE INVENTION

This summary is provided to introduce a variety of concepts in a simplified form that is further disclosed in the detailed description. This summary is not intended to identify key or essential inventive concepts of the claimed subject matter, nor is it intended for determining the scope of the claimed subject matter.

In one aspect, a dynamic calendar and scheduling system having a display in communication with a computing device. The display illustrates a timeline having a plurality of prescheduled calendar events. A processor is in operable communication with the computing device and identifies a gesture via a sensing module. A zoom module determines whether the gesture corresponds to a zooming-in or a zooming-out. The magnitude of the gesture is measured by a time scale calculation module, and an adjusted timeline is displayed based on user-determined magnification.

In one aspect, the display is a touchscreen display permitting the user to drag one or more digits along the touchscreen display while the magnitude of the gesture corresponds to the length of which the one or more digits were dragged along the touchscreen display.

In one aspect, the plurality of prescheduled calendar events includes an alert icon. The alert icon can be scheduled at a time interval corresponding with the prescheduled calendar event.

In one aspect, a third-party server and a third-party database are configured to transmit information related to one or more third-party applications. The transmitted application is then displayed on the timeline.

### BRIEF DESCRIPTION OF THE DRAWINGS

A more complete understanding of the present embodiments and the advantages and features thereof will be more readily understood by reference to the following detailed description when considered in conjunction with the accompanying drawings wherein:

FIG. 1 illustrates a block diagram of a data processing system and network configuration providing a calendar system, according to some embodiments;

FIG. 2A illustrates a block diagram of the network infrastructure, according to some embodiments;

FIG. 2B illustrates a block diagram of the server engine and modules, according to some embodiments;

FIG. 3A illustrates an exemplary screenshot of the calendar system at a first time scale, according to some embodiments;

FIG. 3B illustrates an exemplary screenshot of the calendar system at a second time scale, according to some embodiments;

FIG. 3C illustrates an exemplary screenshot of the calendar system at a third time scale, according to some embodiments;

FIG. 4 illustrates a screenshot of the calendar system interface provided on the display of a computing device, according to some embodiments;

FIG. 5 illustrates a screenshot of the calendar system interface provided on the display of a computing device, according to some embodiments; and

FIG. 6 illustrates a screenshot of the calendar system interface provided on the display of a computing device, according to some embodiments.

### DETAILED DESCRIPTION

The specific details of the single embodiment or variety of embodiments described herein are to the described system. Any specific details of the embodiments are used for demonstration purposes only, and no unnecessary limitations or inferences are to be understood therefrom.

Before describing in detail exemplary embodiments, it is noted that the embodiments reside primarily in combinations of components related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the system relates to a calendar and scheduling application which can be provided on the display of a mobile or non-mobile computing device. The system includes an interactive interface allowing the user to view scheduled events by interacting with a user interface, such as by performing the actions of zooming in and zooming out to view varying intervals of time on a calendar.

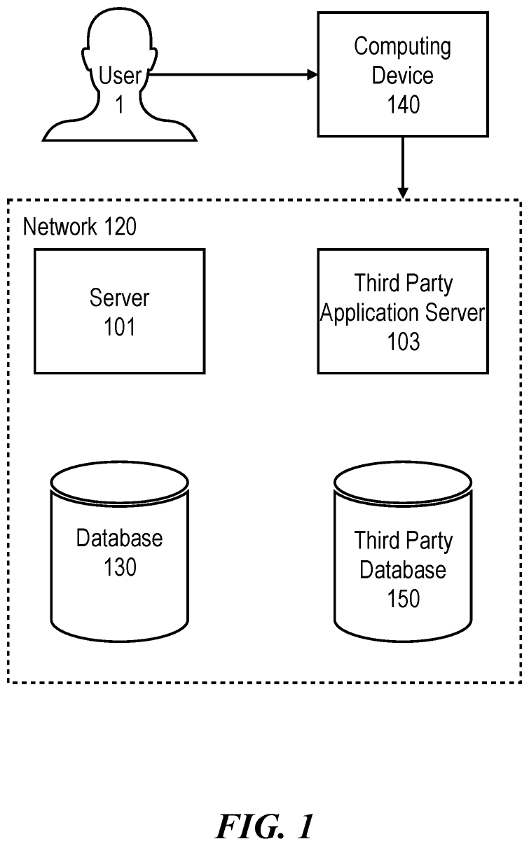

FIG. 1 illustrates a primary server 101 in operable communication with a network 120, such as the Internet. The primary server 101 is in communication with the primary database 130 which contains calendar data for users 1 of the system 100. One or more third-party application servers 103 are each in communication with at least one third party database 150. The third-party application servers 103 can send and receive information from auxiliary applications such as email, contacts, or any application downloaded to the computing device 140 which schedules information in a calendar.

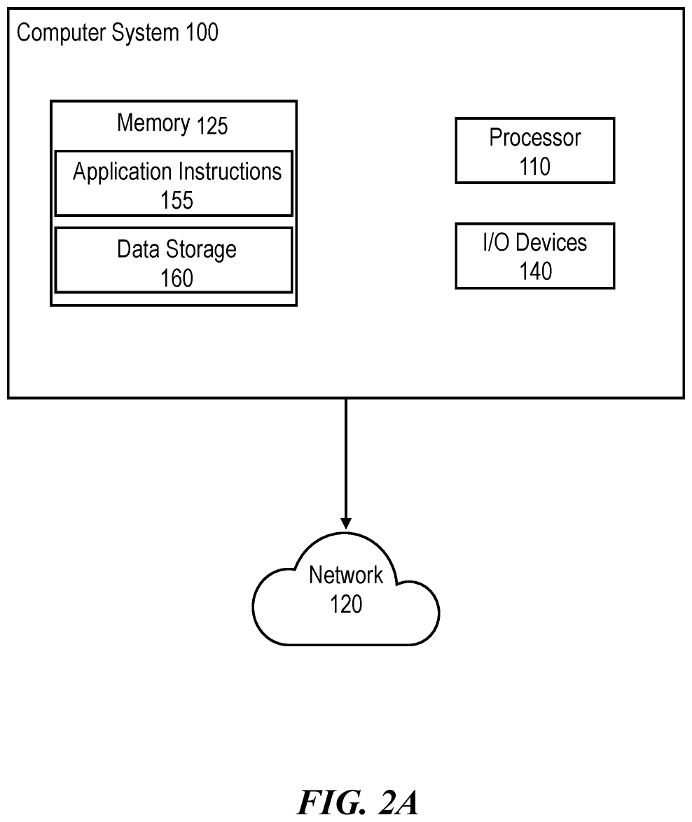

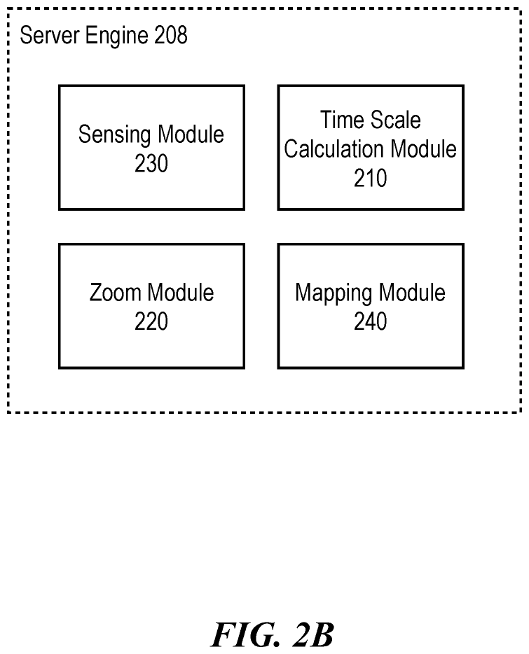

FIG. 2A illustrates a computer system 100, which may be utilized to execute the processes described herein. The computing system 100 is comprised of a standalone computer or mobile computing device, a mainframe computer system, a workstation, a network computer, a desktop computer, a laptop, or the like. The computer system 100 includes one or more processors 110 coupled to a memory 125 via an input/output (I/O) interface. Computer system 100 may further include a network interface to communicate with the network 120. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 120, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 125 may include application instructions 155, configured to implement certain embodiments described herein, and a data storage 160, comprising various data accessible by the application instructions 155. In one embodiment, the application instructions 155 may include software elements corresponding to one or more of the various embodiments described herein. For example, application instructions 155 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented in which a network server executes enterprise and custom software, exchanging data with custom client applications running on the computing device.

In some embodiments, users interact with a computing device having a processor and a memory. A computer program (calendar application 300) is encoded to carry out the present system. The computing device can also serve to be used with user interface hardware, including input/output devices. The user interface hardware is, for example, a pointing device, a keyboard, a touchscreen, or similar implements which are employed to input data to the processor, or a display that visually provides data to a user. A specific example of the computing device is a portable personal computer, a smartphone, or a tablet.

In reference to FIG. 2B, the computing device is in communication with a server engine 208 comprising various modules to perform the functionalities of the system described herein. The modules may include a time scale calculation module 210 coupled to a zoom module 220 and a sensing module 230, each of which may be coupled to the display. The display may include sensors making the display an operable touchscreen display as known in the arts. The sensors of the display may be a capacitive touch detection sensor or likewise touch sensor, configured to detect and track movement on the surface and/or in the vicinity of the display. The sensor may be coupled to a signal processing circuit that is configured to identify, locate, and/or track movement based on the data obtained from sensors.

In some embodiments, the sensing module 230 identifies a gesture, such as a touch, drag, swipe, or likewise gesture. The time scale calculation module 210 may include functionality for identifying a touched first point and a second point within a calendar application displaying a timeline across a first time scale. The time scale calculation module 210 may include functionality for calculating a change in a distance between the first point and the second point in response to a dragging of at least one of the touched points, scaling the calculated change in distance with a scaling factor that varies for different units of time in the calendar application, and determining a scaled calculated change in distance by the width of the displayed timeline and by an adjustment factor to calculate a date change amount.

The zoom module 220 may include functionality for identifying whether a dragging gesture corresponds to zooming in or zooming out based on the calculated distance change. The zoom module 220 may also include functionality for adjusting a start date and an end date of the displayed timeline by the calculated date change amount according to whether the dragging is identified as corresponding to the zooming in or the zooming out.

The time scale calculation 210 module may include functionality for changing a time scale shown in the timeline displayed across the first time scale based on the adjusting of the start date and the end date.

A mapping module 240 may receive transportation, traffic, or similar map data from a third party application via the third party application server. The mapping module 240 may allow for the length of an event to be accurately calculated by determining the time it will take the event participants to travel to and from the event as well as determine the time it will take to travel during the event itself.

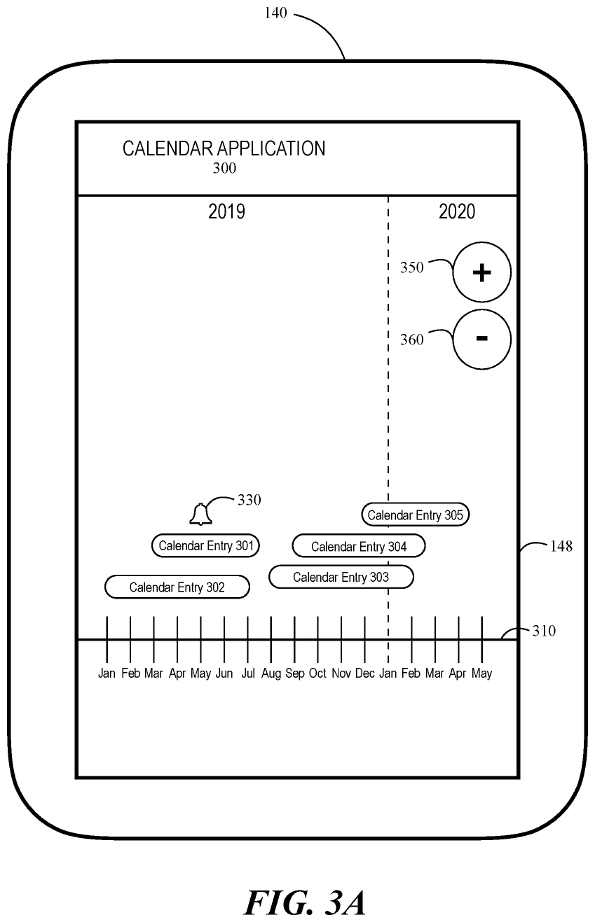

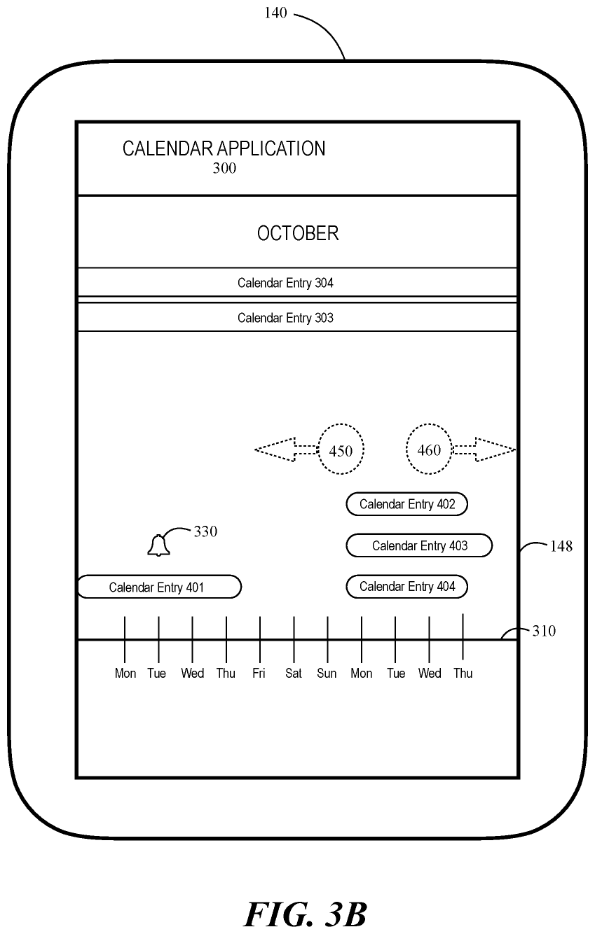

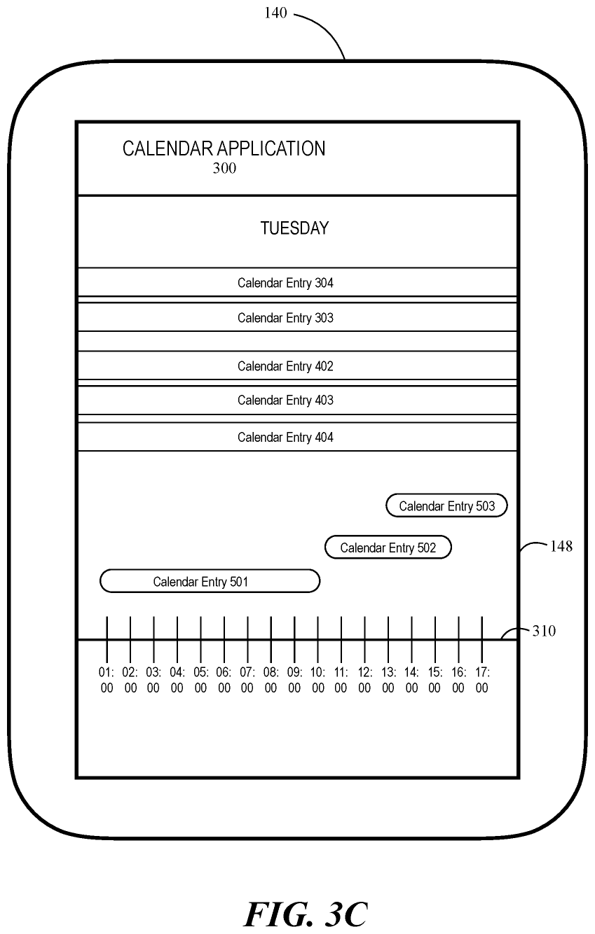

FIG. 3A, FIG. 3B, and FIG. 3C illustrate the dynamic calendar application 300 provided on the display 148 of the device 140. FIG. 3A illustrates an exemplary embodiment of a first time scale spanning multiple years, having months ordered chronologically on a timeline portion 310. Calendar entries 301, 302, 303, 304, 305 entered by the user 1 and stored in database 130 and shown on the display 148. In one example, the user 1 has created a calendar entry 301 for a long-term travel period between March 2019 and July 2019.

In some embodiments, a zoom-in button 350 and a zoom-out button 360 may be provided on the display 148 it is understood that both the zoom-in button 350 and zoom-out button 360 may be incorporated with a touchscreen display as known in the arts.

In some embodiments, an alert icon 330 informs the user 1 of a predetermined alert at a particular day and time.

FIG. 3B illustrates a second time scale wherein the user has zoomed in to view the calendar to a particular week in October such that the timeline portion 310 now displays days of the week in chronological order. Calendar entries 303 and 304 may still be displayed, in addition to more detailed calendar entries 401, 402, 403, 404 that each span the period of time on the order of days, rather than months (as shown in FIG. 3A). An alternative embodiment is provided wherein touch regions 450 and 460 indicate a region on the display (such as a touchscreen display) wherein the user 1 drags their fingers to zoom in or zoom out resulting in a change in time scale provided by the timeline portion 310.

FIG. 3C illustrates a third time scale wherein the user has zoomed in to a particular day of the week. The timeline portion 310 now displays hours of the day in chronological order. Calendar entries 303, 304, 401, 402, 403, and 404 may still be displayed, in addition to more detailed calendar entries 501, 502, and 503 that each span the period of time on the order of hours.

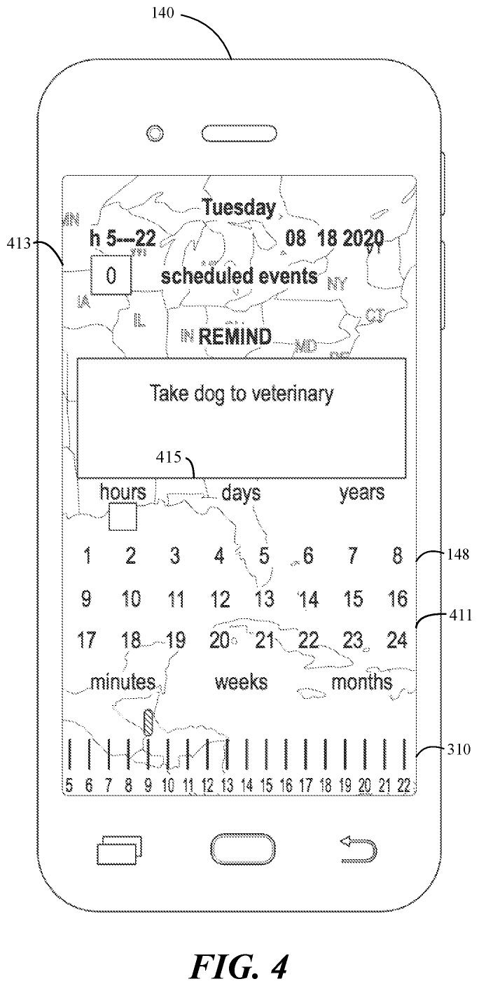

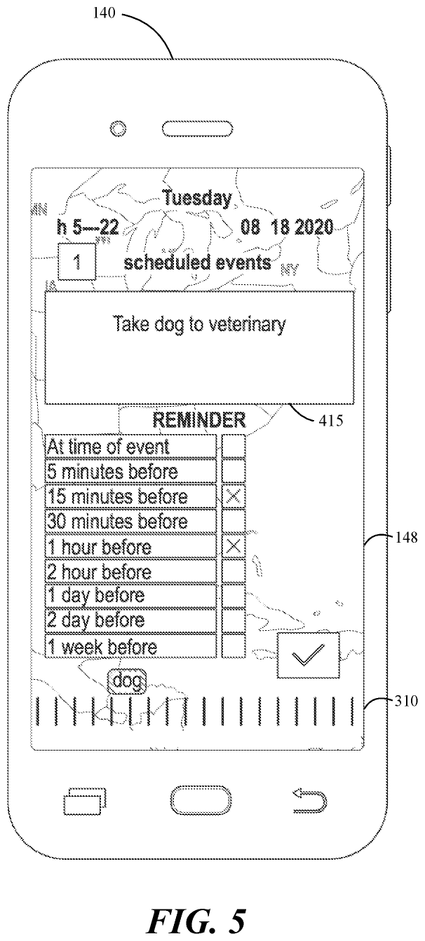

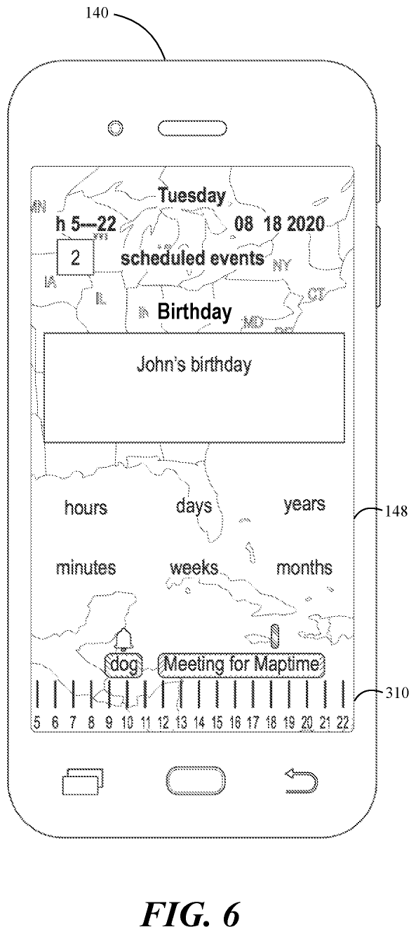

FIG. 4, FIG. 5, and FIG. 6 illustrate exemplary embodiments of the calendar application 300 provided on the computing device 140 display 148. During use, the user 1 may schedule a reminder/alert to generate an alert icon 330 (as shown in FIG. 3A) for a particular calendar event. The user 1 may choose to generate text indicating the details of the calendar event such as “take dog to veterinarian.” The user 1 can then select the hour this occurs on the particular day of the event In the example shown in FIG. 4, the user 1 is scheduling a reminder to take their dog to the veterinarian on Tuesday, Aug. 18, 2020. Hours of the day are shown allowing the user 1 to select one or more hours to schedule the calendar event.

In reference to FIG. 5, the user 1 is scheduling a reminder at predetermined time intervals for the calendar event scheduled in FIG. 4. Input portion 415 allows the user 1 to use an I/O device 140 to enter text to label the scheduled event.

FIG. 6 illustrates an exemplary embodiment showing a scheduled event for a birthday prescheduled calendar events are shown at the timeline portion 310. In some embodiments, units of time, including minutes, hours, days, weeks, months, and years, are provided on the display 148 permitting the user to select the time scale they prefer to view on the timeline portion 310.

In some embodiments, the calendar application may provide an events total for the time scale shown on the display 148. FIG. 6 illustrates a timeline portion 310 which indicates two events for the particular day including a veterinary appointment entitled “dog” and a meeting.

In some embodiments, a user 1 views calendar content in a linear timeline. The timeline may dynamically zoom into and out of the timeline according to input from the user. The display 148 shows the system 100 having a calendar portion 411 (see FIG. 4), an event input portion 413 (see FIG. 4), and a timeline portion 310. During use, the user 1 uses the I/O devices 140 to input an event at the input portion 415 (see FIG. 4). Once the event is created, the event is given a date and time during which the event is scheduled. Scheduling can be input at various units of time, including seconds, minutes, hours, days, weeks, months, years, or otherwise useful units of time.

In some embodiments, the User 1 inputs to zoom in or zoom out on the timeline can include a zoom in button 350 and a zoom out button 360.

In some embodiments, the timeline portion 310 may be zoomed in or out by a double-click using a mouse (IO device) or a double-tap if the computing device includes a touchscreen display. Further, the user can perform two-fingered gestures to “pinch” the screen to perform a zoom in or zoom out function. One skilled in the arts will understand that a variety of controls and gestures can be utilized to zoom in or out on the timeline to change the viewable range along the timeline portion 310. Zoom increment levels may be smooth or stepped.

In some embodiments, one or more zoom levels are displayed on the display 148. Zoom levels may include a month's view, a day view, or an hour view in addition to other permutations of time.

As the user 1 zooms into the timeline portion 310, additional detailed information can be displayed. On the contrary, information may be consolidated, aggregated, or generalized information may displayed as the user 1 zooms out of the timeline portion 310.

During operation, the user 1 is provided with a timeline across a first time scale is displayed on a display 148 of the computing device. The user may then zoom in or zoom out, resulting in a change to a second time scale displaying a different period of time. In an example, the user 1 is provided with a timeline which includes an entire month, with the month defining the first time scale. The user then performs a zoom in function, such as by selecting two point on a touchscreen display 148 interfaces simultaneously and pinching the two points together. This results in the display zooming on to a second time scale, such as a single day.

In some embodiments, the user may drag their finger across the display 148 to pan the timeline in a chronological manner.

In some embodiments, when a user 1 performs zoom in or zoom out procedures on the timeline portion 310, the time interval at a central portion of the timeline may remain constant while the distal portions of the timeline change.

In some embodiments, information displayed can include information about the activities, tasks, or events associated with each calendar entry In one example, each calendar entry can include a status indicator to display the progress of the activity, such as complete or in-progress.

In some embodiments, third-party applications update the calendar application 300 and timeline 310 of scheduled events to provide a graphical representation of the user's 1 schedule over a user-determined time scale. In one example, the user 1 creates a calendar event for taking their dog to the veterinarian. A map application determines the travel time to the veterinarian is 20 minutes. The 20-minute travel time is illustrated in the calendar application's timeline 310 to alert the user 1 of the time necessary to travel to the appointment.

In some embodiments, the zoom in and zoom out transitions the mathematical formula of the conversion from milliseconds to pixels used to draw the minutes, hours, days, months, and years views. The system may utilize an iterator which iterates from left to right with different intervals depending on the view displayed.

In some embodiments, to view events the system utilizes a conversion formula used to identify the points on the XY axis on the display. For overlapping events, the event design algorithm takes into account the length of the event. Events with shorter lengths are drawn first closer to the line, after the others, taking advantage of the Y-axis.

To calculate the start date and end date of an event, the system uses the inverse pixel to millisecond transformation formula.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A dynamic calendar and scheduling system comprising:
a display in communication with a computing device, the display configured to display a timeline having a plurality of prescheduled calendar events;
a processor in operable communication with the computing device, the processor operable to identify a gesture via a sensing module in communication with the display;
a zoom module in operable communication with the processor, the zoom module configured to determine whether the gesture corresponds to zooming in or zooming out of the display; and
a time scale calculation module configured to determine a magnitude of the gesture to permit the display of an adjusted timeline according to the magnitude of the gesture;
wherein the zoom module uses a millisecond to pixel transformation formula to determine the amount of zooming-in or zooming-out.

2. The system of claim 1, wherein the display is a touchscreen display, and wherein the gesture is a user dragging two or more digits along the touchscreen display.

3. The system of claim 2, wherein the magnitude of the gesture corresponds to the length of which the two or more digits were dragged along the touchscreen display.

4. The system of claim 1, wherein the plurality of prescheduled calendar events include an alert icon provided by the display.

5. The system of claim 4, wherein the alert icon is scheduled at a time interval in correspondence with the prescheduled calendar event.

6. The system of claim 1, further comprising a third-party server and a third-party database configured to transmit information related to one or more third-party applications, and wherein the transmitted information is displayed on the timeline.

7. A computer-implemented method for providing a dynamic calendar system on a computing device, the method comprising:
displaying, via a computing device having a processor, a timeline having a plurality of prescheduled calendar events;
identifying a gesture, via a sensing module;
determining, via a zoom module, whether the gesture corresponds to a zooming in or zooming out;
measuring, via a time scale calculation module, the magnitude of the gesture; and
displaying, via the display, an adjusted timeline according to the magnitude of the gesture;
wherein the zoom module uses a millisecond to pixel transformation formula to determine the amount of zooming in or zooming out.

8. The method of claim 7, wherein the display is a touchscreen display, and wherein the gesture is a user dragging two or more digits along the touchscreen display.

9. The method of claim 8, wherein the magnitude of the gesture corresponds to the length of which the two or more digits were dragged along the touchscreen display.

10. The method of claim 7, wherein the plurality of prescheduled calendar events includes an alert icon.

11. The method of claim 10, wherein the alert icon is scheduled at a time interval in correspondence with the prescheduled calendar event.

12. The method of claim 7, further comprising a third-party server and a third-party database configured to transmit information related to one or more third-party applications, and wherein the transmitted information is displayed on the timeline.

13. A dynamic calendar and scheduling system comprising:
a display in communication with a computing device, the display configured to display a timeline having a plurality of prescheduled calendar events;
a processor in operable communication with the computing device, the processor operable to identify a gesture via a sensing module in communication with the display;
a zoom module in operable communication with the processor, the zoom module configured to determine whether the gesture corresponds to zooming in or zooming out of the display;
a time scale calculation module configured to determine the magnitude of the gesture to permit the display of an adjusted timeline according to the magnitude of the gesture; and
a mapping module to determine a length of time for an event;
wherein the zoom module uses a millisecond to pixel transformation formula to determine the amount of zooming in or zooming out.

14. The system of claim 13, wherein the plurality of prescheduled calendar events includes an alert icon.

15. The system of claim 14, wherein the alert icon is scheduled at a time interval in correspondence with the prescheduled calendar event.

16. The system of claim 15, further comprising a third-party server and a third-party database configured to transmit information related to one or more third-party applications, and wherein the transmitted information is displayed on the timeline.

17. The system of claim 16, wherein the one or more third-party applications transmit scheduling data to the database, via a third party application server.

18. The system of claim 17, wherein the mapping module receives transportation data from at least one of the third party applications.
